(19) United States
(12) Patent Application Publication
(10) Pub. No.: US 2012/0089649 A1
(43) Pub. Date: Apr. 12, 2012

(54) METHOD AND APPARATUS FOR MANAGING VIRTUAL WORLD

(75) Inventors: Sang-Hyun Joo, Daejeon (KR); Il-Kwon Jung, Daejeon (KR); Byoung-Tae Choi, Daejeon (KR)

(73) Assignee: Electronics and Telecommunications Research Institute, Daejeon (KR)

(21) Appl. No.: 13/269,270

(22) Filed: Oct. 7, 2011

Related U.S. Application Data
(60) Provisional application No. 61/391,411, filed on Oct. 8, 2010.

(30) Foreign Application Priority Data
Nov. 2, 2010 (KR) 10-2010-0108417

(51) Int. Cl. G06F 17/30

(52) U.S. Cl. 707/821

(57) ABSTRACT

Disclosed is a method for managing a virtual world. The method for managing a virtual world includes: receiving virtual world management information including user information and communication information; and managing a virtual world, objects in the virtual world, and relationships between the objects using the virtual world management information.

### CROSS-REFERENCES TO RELATED APPLICATIONS

The present application claims priority of U.S. Patent Application No. 61/391,411 and Korean Patent Application No. 10-2010-0108417, filed on Oct. 8, 2010 and Nov. 2, 2010, which are incorporated herein by reference in their entirety.

### BACKGROUND OF THE INVENTION

1. Field of the Invention

Exemplary embodiments of the present invention relate to an apparatus and a method for managing a virtual world.

2. Description of Related Art

With the development of computer operation function and graphic processing capability and popularization of high-speed Internet line, various three-dimensional online games have been generalized. Further, unlike games achieving specific purposes, a ‘life-type virtual reality’ service that can three-dimensionally implement a real living space and thus, experience virtual reality has also been commercialized.

In particular, the life-type virtual reality service provide environment similar to real environment so as to implement real life in a virtual space. In this case, the life-type virtual reality service needs to provide a three-dimensional stereoscopic space that is similar to reality or is difficult to be searched in real environment and set various correlations between users and implement a natural user avatar.

It is important to consider all relationships existing in a virtual world during a process of creating the virtual world. It is also important for an operator or a manager in the virtual world to manage all types of interactions in the virtual world and reaction created by a user in a real world and to reflect attributes of objects in a real world. However, there is a need to consider efficiency of generation and management in the virtual world. The management is associated with a user in the real world and thus, handles a general structure in the virtual world so as to cover all the relationships existing in the virtual world and the real world. In accordance with an embodiment of the present invention, it is expect to develop various and new business models based on the virtual world. In addition, it is possible to reflect a trend in the real world and lead a trend in the virtual world.

### SUMMARY OF THE INVENTION

An embodiment of the present invention is directed to a method and an apparatus for managing a virtual world capable of more effectively managing objects in a virtual world and relationships having the objects.

The objects of the present invention are not limited to the above-mentioned objects and therefore, other objects and advantages of the present invention that are not mentioned may be understood by the following description and will be more obviously understood by exemplary embodiments of the present invention. In addition, it can be easily appreciated that objects and advantages of the present invention may be implemented by means and a combination thereof described in claims.

In accordance with an embodiment of the present invention, a method for managing a virtual world includes:

receiving virtual world management information including user information and communication information; and managing a virtual world, objects in the virtual world, and relationships between the objects using the virtual world management information.

In accordance with another embodiment of the present invention, an apparatus for managing a virtual world includes: an input unit configured to receive virtual world management information including user information and communication information; and a management unit configured to manage a virtual world, objects in the virtual world, and relationships between the objects using the virtual world management information.

### BRIEF DESCRIPTION OF THE DRAWINGS

FIG. 1 is a configuration diagram of an apparatus for managing a virtual world in accordance with an embodiment of the present invention.

FIG. 2 is a flow chart of a method for managing a virtual world in accordance with an embodiment of the present invention.

FIG. 3 is a diagram illustrating a hierarchical structure of virtual world management information in accordance with the embodiment of the present invention.

FIG. 4 is a diagram illustrating a hierarchical structure of user information in accordance with the embodiment of the present invention.

FIG. 5 is a diagram illustrating a hierarchical structure of user profile information in accordance with the embodiment of the present invention.

FIG. 6 is a diagram illustrating a hierarchical structure of communication information in accordance with the embodiment of the present invention.

FIG. 7 is a diagram illustrating a hierarchical structure of current status information in accordance with the embodiment of the present invention.

FIG. 8 is a diagram illustrating a hierarchical structure of interest information in accordance with the embodiment of the present invention.

FIG. 9 is a diagram illustrating a hierarchical structure of relationship information in accordance with the embodiment of the present invention.

FIG. 10 is a diagram illustrating a hierarchical structure of popularity information in accordance with the embodiment of the present invention.

FIG. 11 is a diagram illustrating a hierarchical structure of interaction information in accordance with the embodiment of the present invention.

FIG. 12 is a diagram illustrating a hierarchical structure of expression modality information in accordance with the embodiment of the present invention.

FIG. 13 is a diagram illustrating a hierarchical structure of linguistic expression information in accordance with the embodiment of the present invention.

FIG. 14 is a diagram illustrating a hierarchical structure of facial expression information in accordance with the embodiment of the present invention.

FIG. 15 is a diagram illustrating a hierarchical structure of gesture information in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

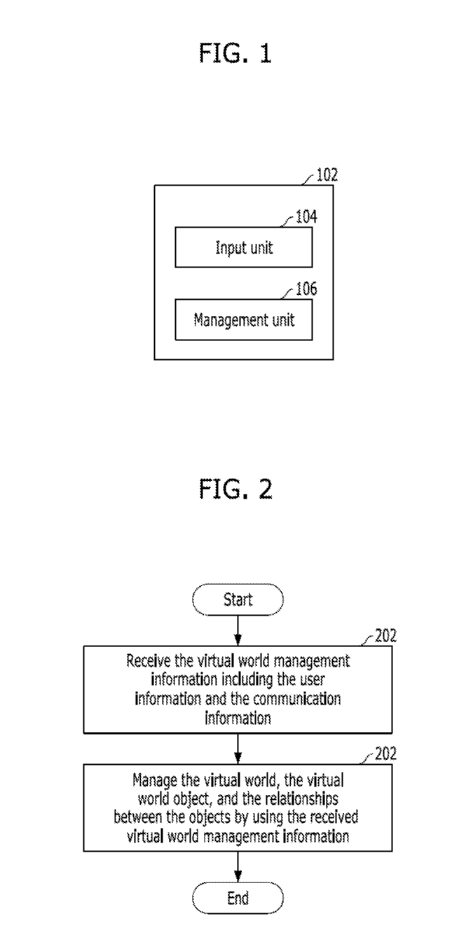

FIG. 1 is a configuration diagram of an apparatus for managing a virtual world in accordance with an embodiment of the present invention.

An apparatus 102 for managing a virtual world in accordance with the embodiment of the present invention includes an input unit 104 and a management unit 106.

The input unit 104 receives virtual world management information including user information and communication information. The user information, which is information describing a user using the virtual world, includes user profile information that is personal information of the user in a real world. The user profile information includes resident registration number information, gender information, age information, address information, phone number information, location information, emotion information, blood pressure information, and heart rate information.

The communication information is information describing communication between different virtual world objects. The communication information includes the current status information, the interaction information, and the expression modality information.

The current status information, which is information describing a current status of the virtual world object, includes name information, ID information, location information, property information, interest information, relationship information, and popularity information. The interest information includes interest name information, celebrity information, interest group information, and interest field information. The relationship information includes relationship name information, interest ID information, virtual world relationship information, and real world relationship information. The popularity information includes information about the number of nominations, information about the number of friends, information about the number of interests, information about the number of activities, information about friends rank, and information about an activity rank.

The interaction information, which is information describing interaction between different virtual world objects, includes avatar-to-avatar relationship information, avatar-to-virtual object relationship information, user-to-avatar relationship information, user-to-virtual object relationship information, and virtual object-to-virtual object relationship information.

The expression modality information, which is information describing expression modality of the virtual world object, includes linguistic expression information, facial expression information, finger movement information, gesture information, and posture information. The linguistic expression information includes voice expression information and text expression information. The facial expression information includes facial expression resource URL information. The gesture information includes gesture resource URL information.

The management unit 106 manages the virtual world, the virtual world object, and the relationship between the objects using the virtual world management information input through the input unit 104. For example, the management unit 206 may detect and manage the information about each user through the user information included in the virtual world management information and manage the communication between the virtual world object by using the communication information.

FIG. 2 is a flow chart of a method for managing a virtual world in accordance with an embodiment of the present invention.

First, the virtual world management information including the user information and the communication information is received (202). As described above, the user information, which is information describing a user using the virtual world, includes the user profile information that is the personal information of the user in the real world. The user profile information includes resident registration number information, gender information, age information, address information, phone number information, location information, emotion information, blood pressure information, and heart rate information.

The communication information is information describing communication between different virtual world objects present in the virtual world. The communication information includes current status information, interaction information, and expression modality information.

The current status information, which is information describing a current status of the virtual world object, includes name information, ID information, location information, property information, interest information, relationship information, and popularity information. The interest information includes interest name information, celebrity information, interest group information, and interest field information. The relationship information includes relationship name information, interest ID information, virtual world relationship information, and real world relationship information. The popularity information includes information about the number of nominations, information about the number of friends, information about the number of interests, information about the number of activities, information about friends rank, and information about an activity rank.

The interaction information, which is information describing interaction between different virtual world objects, avatar-to-avatar relationship information, avatar-to-virtual object relationship information, user-to-avatar relationship information, user-to-virtual object relationship information, and virtual object-to-virtual object relationship information.

The expression modality information, which is information describing expression modality of the virtual world object, includes linguistic expression information, facial expression information, finger movement information, gesture information, and posture information. The linguistic expression information includes voice expression information and text expression information. The facial expression information includes facial expression resource URL information. The gesture information includes gesture resource URL information.

Next, the virtual world, the virtual world object, and the relationships between the objects are managed by using the received virtual world management information (204).

Hereinafter, a structure in the virtual world management information used in the method and the apparatus for managing a virtual world in accordance with the embodiment of the present invention will be described.

The users in the virtual world have their own interest information, activities to which the users belong, users' profile, and popularity of the virtual world object. It is important to reflect the information from the virtual world and the real world to a daily life of a user. The management concept may be implemented by the relationship between different virtual world objects.

The related art has no a method for describing the relationship between different virtual world objects as well as interaction between the users in the virtual world. The embodiment of the present invention proposes the control and management concept for defining all the relationships between the virtual world and the real world. In accordance with the embodiment of the present invention, the operator can clearly understand the virtual world structure helping the operator to manage the virtual world. In addition, the embodiment of the present invention can perform an important role capable of stimulating the virtual world boom while proposing a new business model in business fields.

According to components present in the virtual world, there is a need to distinguish avatars and virtual objects in order to help clear understanding as independent shapes.

Next, the structure in the virtual world management information used in the method and the apparatus for managing a virtual world in accordance with the embodiment of the present invention will be described.

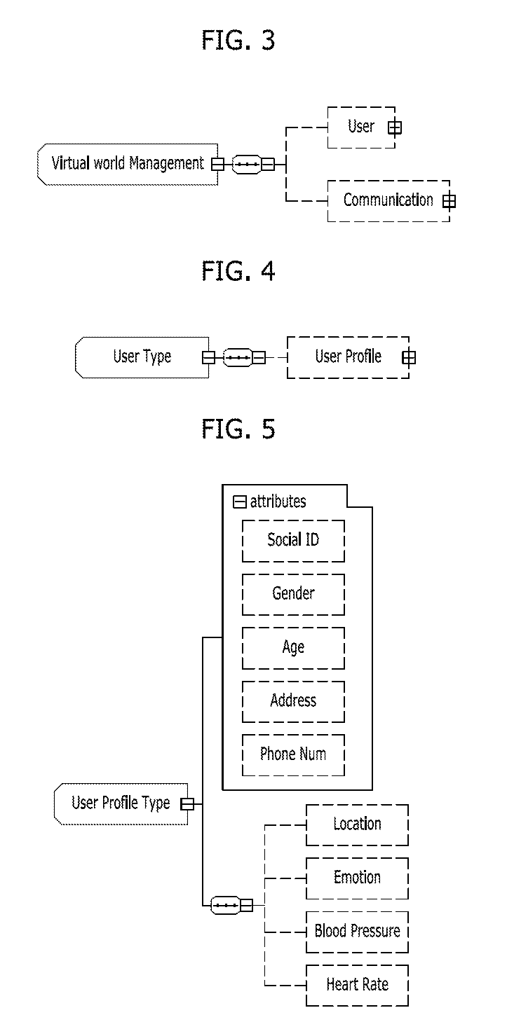

FIG. 3 is a diagram illustrating a hierarchical structure in the virtual world management information in accordance with the embodiment of the present invention.

As illustrated in FIG. 3, the virtual world management information (VirtualWorldManagementType) includes the user information and the communication information. Semantics of each element illustrated in FIG. 3 are shown in the following Table 1.

TABLE 1

| Name | Description |
|---|---|
| User | Describes the information about user. |
| Communication | Describes the information about communication |
| | existing different Virtual World Object. |

A source code for implementing the virtual world management information of FIG. 3 is as follows.

```
    <xsd:complexType name=“VirtualWorldManagementType”
abstract=“true”>
    <xsd:sequence>
    <xsd:element name=“User” type=“UserType”
minOccurs=“0”/>
    <xsd:element name=“Communication”
type=“CommunicationType” minOccurs=“0”/>
    </xsd:sequence>
    </xsd:complexType>
```

FIG. 4 is a diagram illustrating a hierarchical structure of user information in accordance with the embodiment of the present invention.

As illustrated in FIG. 4, the user information (UserType) includes user profile information (UserProfile). Semantics of each element illustrated in FIG. 4 are shown in the following Table 2.

TABLE 2

| Name | Description |
|---|---|
| UserProfile | Describes personal information of user in real |
| | world. |

The source code for implementing the user information of FIG. 4 is as follows.

```
    <xsd:complexType name=“UserType” abstract=“true”>
    <xsd:sequence>
    <xsd:element name=“UserProfile”
type=“UserProfileType” minOccurs=“0”/>
    </xsd:sequence>
    </xsd:complexType>
```

FIG. 5 is a diagram illustrating a hierarchical structure of user profile information in accordance with the embodiment of the present invention.

As illustrated in FIG. 5, the user profile information (UserProfileType) includes resident registration number information (SocialID), gender information (Gender), age information (Age), address information (Address), and phone number information (PhoneNum). In addition, the user profile information (UserProfileType) includes location information (Location), emotion information (Emotion), blood pressure information (BloodPressure), and heart rate information (HeartRate).

Semantics of each element illustrated in FIG. 5 are shown in the following Table 3.

TABLE 3

| Name | Description |
|---|---|
| SocialID | Describes the social identification of user in |
| | real world. |
| Gender | Describes the gender of user in real world. (1: |
| | Woman 2: Man) |
| Age | Describes the age of user in real world. |
| Address | Describes the address of user in real world. |
| PhoneNum | Describes the phone number of user in real |
| | world. |
| Location | Describes the location of user in real world. |
| Emotion | Describes the emotion of user in real world. |
| BloodPressure | Describes the blood pressure of user in real |
| | world. |
| HeartRate | Describes the heart rate of user in real world. |

The source code for implementing the user profile information of FIG. 5 is as follows.

```
    <xsd:complexType name=“UserProfileType”
abstract=“true”>
    <xsd:sequence>
    <xsd:element name=“Location” type=“LocationType”
minOccurs=“0”/>
    <xsd:element name=“Emotion” type=“EmotionType”
minOccurs=“0”/>
    <xsd:element name=“BloodPressure”
type=“BloodPressureType” minOccurs=“0”/>
    <xsd:element name=“HeartRate” type=“HeartRateType”
minOccurs=“0”/>
    </xsd:sequence>
    <xsd:attribute name=“SocialID” type=“xsd:unsignedInt”
use=“optional”/>
```

| | |
|---|---|
| <xsd:attribute name=“Gender” | type=“xsd:unsignedInt” |
| use=“optional”/> | |
| <xsd:attribute name=“Age” | type=“xsd:unsignedInt” |
| use=“optional”/> | |
| <xsd:attribute name=“Address” | type=“xsd:unsignedInt” |
| use=“optional”/> | |
| <xsd:attribute name=“PhoneNum” | type=“xsd:unsignedInt” |
| use=“optional”/> | |
| </xsd:complexType> | |

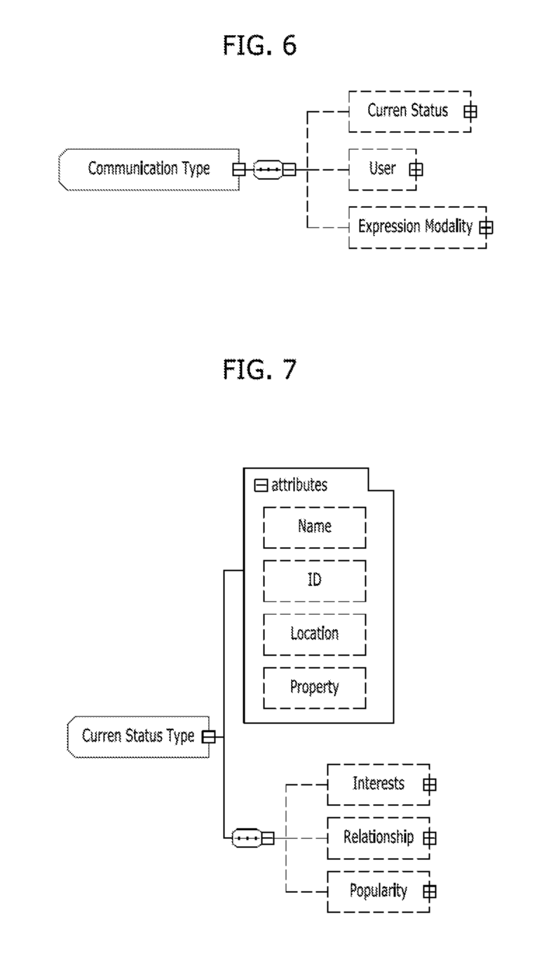

FIG. 6 is a diagram illustrating a hierarchical structure of communication information in accordance with the embodiment of the present invention.

As illustrated in FIG. 6, the communication information (CommunicationType) includes current status information (CurrentStatus), interaction information (Interaction), and expression modality information (ExpressionModality). Semantics of each element illustrated in FIG. 6 are shown in the following Table 4.

TABLE 4

| Name | Description |
|---|---|
| CurrentStatus | Describes current status of virtual world |
| | object. |
| Interaction | Describes interaction between different virtual |
| | world object. |
| ExpressionModaility | Describes expression modality of virtual world |
| | object. |

The source code for implementing the communication information of FIG. 6 is as follows.

| | |
|---|---|
| <xsd:complexType | name=“CommunicationType” |

abstract=“true”>
<xsd:sequence>

| | |
|---|---|
| <xsd:element | name=“CurrentStatus” |

type=“CurrentStatusType” minOccurs=“0”/>

| | |
|---|---|
| <xsd:element | name=“Interaction” |

type=“InteractionType” minOccurs=“0”/>

| | |
|---|---|
| <xsd:element | name=“ExpressionModality” |

```
type=“ExpressionModalityType” minOccurs=“0”/>
    </xsd:sequence>
    </xsd:complexType>
```

FIG. 7 is a diagram illustrating a hierarchical structure of current status information in accordance with the embodiment of the present invention.

As illustrated in FIG. 7, the current status information (CurrentStatusType) includes name information, ID information (ID), location information (Location), and property information (Property). In addition, the current status information (CurrentStatusType) includes interest information (Interestes), relationship information (Relationship), and popularity information (Popularity). Semantics of each element illustrated in FIG. 7 are shown in the following Table 5.

TABLE 5

| Name | Description |
|---|---|
| Name | Describes name of virtual world object. |
| ID | Describes identification of virtual world |
| | object. |
| Location | Describes location of virtual world object. |
| Property | Describes property of virtual world object. |
| Interests | Describes interests of virtual world object to |
| | other virtual world object. |
| Relationship | Describes relationship of different virtual |
| | world object. |
| Popularity | Describes popularity of virtual world object. |

The source code for implementing the current status information of FIG. 7 is as follows.

| | |
|---|---|
| <xsd:complexType | name=“CurrentStatusType” |

```
abstract=“true”>
    <xsd:sequence>
    <xsd:element name=“Interests” type=“InterestsType”
minOccurs=“0”/>
```

| | |
|---|---|
| <xsd:element | name=“Relationship” |

```
type=“RelationshipType” minOccurs=“0”/>
    <xsd:element name=“Popularity” type=“PopularityType”
minOccurs=“0”/>
    </xsd:sequence>
```

| | |
|---|---|
| <xsd:attribute name=“Name” | type=“xsd:unsignedInt” |
| use=“optional”/> | |
| <xsd:attribute name=“ID” | type=“xsd:unsignedInt” |
| use=“optional”/> | |

| | |
|---|---|
| <xsd:attribute | name=“Location” |

type=“xsd:unsignedInt” use=“optional”/>

| | |
|---|---|
| <xsd:attribute | name=“Property” |

type=“xsd:unsignedInt” use=“optional”/>
</xsd:complexType>

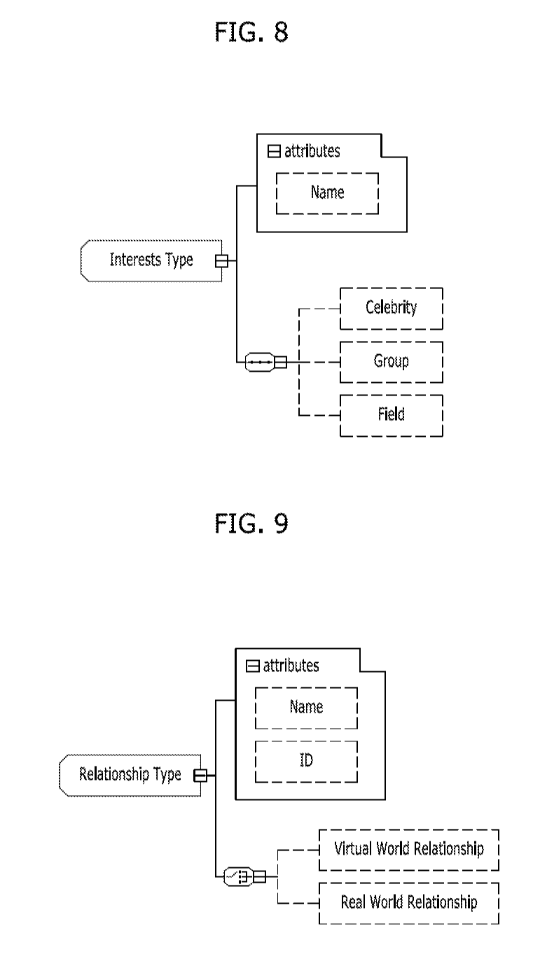

FIG. 8 is a diagram illustrating a hierarchical structure of interest information in accordance with the embodiment of the present invention.

As illustrated in FIG. 8, the interest information (InterestsType) includes interest name information (Name), celebrity information (Celebrity), interest group information (Group), and interest field information (Field). Semantics of each element illustrated in FIG. 8 are shown in the following Table 6.

TABLE 6

| Name | Description |
|---|---|
| Name | Describes name of interest for virtual world |
| | object. |
| Celebrity | Describes vary celebrity existing in real world. |
| Group | Describes vary group that virtual world object |
| | get interests. |
| Field | Describes vary field that virtual world object |
| | get interests |

The source code for implementing the interest information of FIG. 8 is as follows.

| | |
|---|---|
| <xsd:complexType | name=“InterestsType” |
| abstract=“true”> | |
| <xsd:sequence> | |

| | |
|---|---|
| <xsd:element | name=“Celebrity” |

type=“CelebrityType” minOccurs=“0”/>

| | |
|---|---|
| <xsd:element name=“Group” | type=“GroupType” |
| minOccurs=“0”/> | |
| <xsd:element name=“Field” | type=“FieldType” |

minOccurs=“0”/>
</xsd:sequence>

| | |
|---|---|
| <xsd:attribute | name=“Name” |
| type=“xsd:unsignedInt” use=“optional”/> | |
| </xsd:complexType> | |

FIG. 9 is a diagram illustrating a hierarchical structure of relationship information in accordance with the embodiment of the present invention.

As illustrated in FIG. 9, the relationship information (RelationshipType) includes relationship name information (Name), ID information (ID), virtual world relationship information (VirtualWorldRelationship), and real world relationship information (RealWorldRelationship). Semantics of each element illustrated in FIG. 9 are shown in the following Table 7.

TABLE 7

| Name | Description |
|---|---|
| Name | Describes name of relation type. |
| ID | Describes identification of relation type. |
| VirtualWorldRelationship | Describes virtual world relationship |
| | reflecting to virtual environment. |
| RealWorldRelationship | Describes real world relationship reflecting |
| | to virtual environment. |

The source code for implementing the relationship information of FIG. 9 is as follows.

| | |
|---|---|
| <xsd:complexType | name=“RelationshipType” |
| abstract=“true”> | |
| <xsd:choice> | |

| | |
|---|---|
| <xsd:element | name=“VirtualWorldRelationship” |

| type=“VirtualWorldRelationshipType” minOccurs=“0”/> | |
|---|---|
| <xsd:element | name=“RealWorldRelationship” |

| type=“RealWorldRelationshipType” minOccurs=“0”/> | |
|---|---|
| </xsd:choice> | |
| <xsd:attribute | name=“Name” |

```
type=“xsd:unsignedInt” use=“optional”/>
        <xsd:attribute name=“ID” type=“xsd:unsignedInt”
use=“optional”/>
        </xsd:complexType>
```

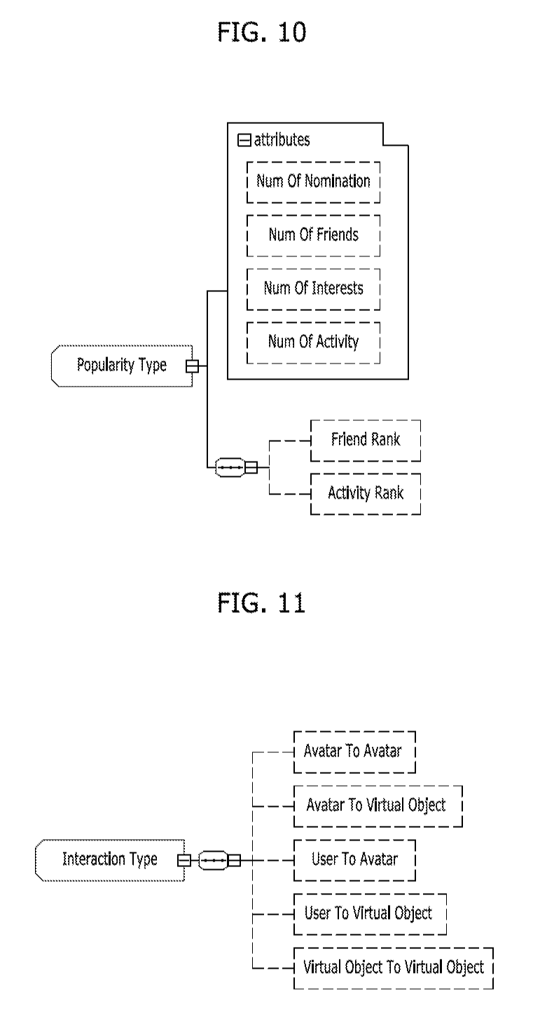

FIG. 10 is a diagram illustrating a hierarchical structure of popularity information in accordance with the embodiment of the present invention.

As illustrated in FIG. 10, the popularity information (PopularityType) includes information about the number of nominations (NumOfNomination), information about the number of friends (NumOfFriends), information about the number of interests (NumOfInterest), information about the number of activities (NumOfActivity), information about (FriendsRank), and information about an activity rank (ActivityRank). Semantics of each element illustrated in FIG. 10 are shown in the following Table 8.

TABLE 8

| Name | Description |
|---|---|
| NumOfNomination | Describes number of nomination made by other |
| | virtual world object. |
| NumOfFriend | Describes number of friends in virtual world. |
| NumOfInterests | Describes number of interests that virtual world |
| | object have. |
| NumOfActivity | Describes number of activity that virtual world |
| | object involved. |
| FriendRank | Describes how many friends virtual world object |
| | have in virtual world. |
| ActivityRank | Describes how many activities virtual world |
| | object have in virtual world. |

The source code for implementing the popularity information of FIG. 10 is as follows.

| | |
|---|---|
| <xsd:complexType | name=“PopularityType” |
| abstract=“true”> | |
| <xsd:sequence> | |

| | |
|---|---|
| <xsd:element | name=“FriendsRank” |
| type=“FriendsRankType” minOccurs=“0”/> | |

| | |
|---|---|
| <xsd:element | name=“ActivityRank” |
| type=“ActivityRankType” minOccurs=“0”/> | |
| </xsd:sequence> | |

| | |
|---|---|
| <xsd:attribute | name=“NumOfNomination” |

type=“xsd:unsignedInt” use=“optional”/>

| | |
|---|---|
| <xsd:attribute | name=“NumOfFriends” |
| type=“xsd:unsignedInt” use=“optional”/> | |
| <xsd:attribute | name=“NumOfInterest” |
| type=“xsd:unsignedInt” use=“optional”/> | |
| <xsd:attribute | name=“NumOfActivity” |
| type=“xsd:unsignedInt” use=“optional”/> | |
| </xsd:complexType> | |

FIG. 11 is a diagram illustrating a hierarchical structure of interaction information in accordance with the embodiment of the present invention.

As illustrated in FIG. 11, the interaction information (InteractionType) includes avatar-to-avatar information (AvartarToAvartar), avatar-to-virtual object information (AvartarToVirtualObject), user-to-avatar information (UserToAvartar), user to virtual object information (UserToVirtualObject), and virtual object-to-virtual object information (VirtualObjectToVirtualObject). Semantics of each element illustrated in FIG. 11 are shown in the following Table 9.

TABLE 9

| Name | Description |
|---|---|
| AvatarToAvatar | Describes the relationship between |
| | avatars to avatars. |
| AvatarToVirtualObject | Describes the relationship between |
| | avatars to virtual object. |
| UserToAvatar | Describes the relationship between |
| | users to avatar. |
| UserToVirtualObject | Describes the relationship between |
| | users to virtual object. |
| VirtualObjectToVirtualObject | Describes the relationship between |
| | virtual objects to virtual object. |

The source code for implementing the interaction information of FIG. 11 is as follows.

| | |
|---|---|
| <xsd:complexType | name=“InteractionType” |
| abstract=“true”> | |
| <xsd:sequence> | |

| | |
|---|---|
| <xsd:element | name=“AvatarToAvater” |

type=“AvatarToAvaterType” minOccurs=“0”/>

| | |
|---|---|
| <xsd:element | name=“AvatarToVirtualObject” |

type=“AvatarToVirtualObjectType” minOccurs=“0”/>

| | |
|---|---|
| <xsd:element | name=“UserToAvater” |

type=“UserToAvaterType” minOccurs=“0”/>

| | |
|---|---|
| <xsd:element | name=“UserToVirtualObject” |

```
type=“UserToVirtualObjectType” minOccurs=“0”/>
        <xsd:element name=“VirtualObjectToVirtualObject”
type=“VirtualObjectToVirtualObjectType” minOccurs=“0”/>
        </xsd:sequence>
        </xsd:complexType>
```

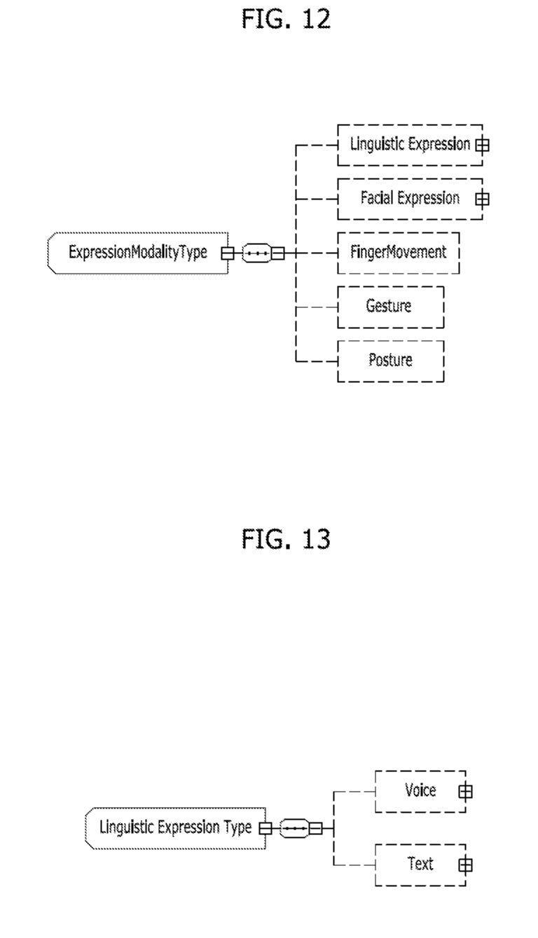

FIG. 12 is a diagram illustrating a hierarchical structure of expression modality information in accordance with the embodiment of the present invention.

As illustrated in FIG. 12, the expression modality information (ExpressionModalityType) includes linguistic expression information (LinguisticExpression), facial expression information (FacialExpression), finger movement information (FingerMovements), gesture information (Gesture), and posture information (Posture). Semantics of each element illustrated in FIG. 12 are shown in the following Table 10.

TABLE 10

| Name | Description |
|---|---|
| LinguisticExpression | Describes linguistic expression in virtual |
| | world. |
| FacialExpression | Describes Facial Expression in virtual world. |
| FingerMovement | Describes Finger Movement in virtual world. |
| Gesture | Describes Gesture in virtual world. |
| Posture | Describes Posture in virtual world. |

The source code for implementing the expression modality information of FIG. 12 is as follows.

| | |
|---|---|
| <xsd:complexType | name=“ExpressionModalityType” |
| abstract=“true”> | |
| <xsd:sequence> | |

| | |
|---|---|
| <xsd:element | name=“LinguisticExpression” |

type=“LinguisticExpressionType” minOccurs=“0”/>

| | |
|---|---|
| <xsd:element | name=“FacialExpression” |

type=“FacialExpressionType” minOccurs=“0”/>

| | |
|---|---|
| <xsd:element | name=“FingerMovements” |

```
type=“FingerMovementsType” minOccurs=“0”/>
        <xsd:element name=“Gesture” type=“GestureType”
minOccurs=“0”/>
        <xsd:element name=“Posture” type=“PostureType”
minOccurs=“0”/>
        </xsd:sequence>
        </xsd:complexType>
```

FIG. 13 is a diagram illustrating a hierarchical structure of linguistic expression information in accordance with the embodiment of the present invention.

As illustrated in FIG. 13, the linguistic expression information (LinguisticExpressionType) includes voice expression information (Voice) and text expression information (Text). Semantics of each element illustrated in FIG. 13 are shown in the following Table 11.

TABLE 11

| Name | Description |
|---|---|
| Voice | Describes voice expression of virtual world |
| | object. |
| Text | Describes text expression of virtual world |
| | object. |

The source code for implementing the linguistic expression information of FIG. 13 is as follows.

```
        <xsd:complexType name=“LinguisticExpressionType”
abstract=“true”>
        <xsd:sequence>
        <xsd:element name=“Voice” type=“ChatType”
minOccurs=“0”/>
        <xsd:element name=“Text” type=“MessageType”
minOccurs=“0”/>
        </xsd:sequence>
        </xsd:complexType>
```

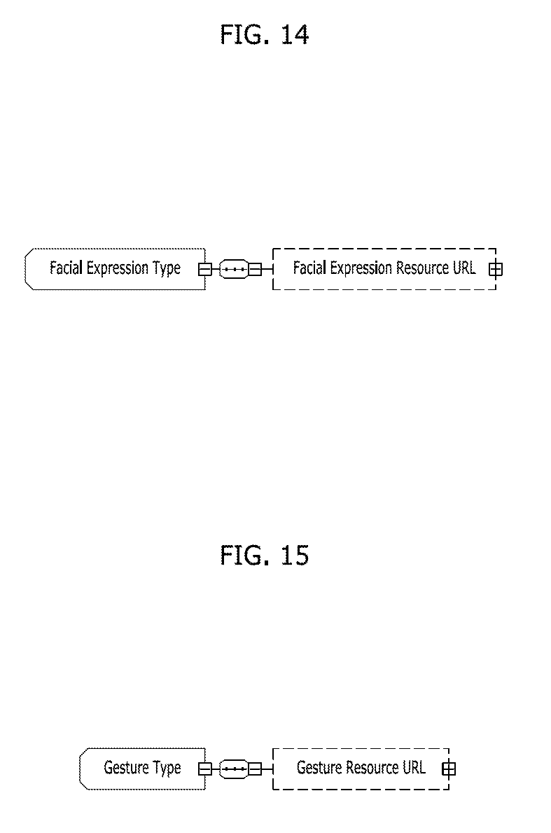

FIG. 14 is a diagram illustrating a hierarchical structure of facial expression information in accordance with the embodiment of the present invention.

As illustrated in FIG. 14, the facial expression information (FacialExpressionType) includes facial expression resource URL information (FacialExpressionResourceURL). Semantics of each element illustrated in FIG. 14 are shown in the following Table 12.

TABLE 12

| | |
|---|---|
| Name | Description |

| FacialExpressionResourceURL | Element that contains, if exist, | |
|---|---|---|
| | one or more link(s) to faction | |
| | expression(s) file(s). | |
| | URL | Contains link to facial |
| | | expression fil [symbol] |

[symbol]

indicates data missing or illegible when filed

The source code for implementing the facial expression information of FIG. 14 is as follows.

```
        <xsd:complexType name=“FacialExpressionType”>
        <xsd:sequence>
        <xsd:element name=“FacialExpressionResourcesURL”
type=“xsd:string”/>
        </xsd:sequence>
        </xsd:complexType>
```

FIG. 15 is a diagram illustrating a hierarchical structure of gesture information in accordance with the embodiment of the present invention.

As illustrated in FIG. 15, the gesture information (GestureType) includes gesture resource URL information (GestureResourceURL). Semantics of each element illustrated in FIG. 15 are shown in the following Table 13.

TABLE 13

| Name | Description |
|---|---|
| GestureResourceURL | Element that contains, if exist, one or |
| | more link(s) to gesture(s) file(s). |

| | |
|---|---|
| URL | Contains link to gesture file |

The embodiment of the present invention proposes the virtual world management concept for integrating all the components in the virtual world. In addition, the embodiment of the present invention defines the important information of the user for the virtual world for the virtual world operator. The embodiment of the present invention can help the operator in the virtual world to efficiently control all the relationships existing in the virtual world. The advantages of the embodiment of the present invention may also be used to define the network established on the virtual world.

As described above, in accordance with the embodiment of the present invention, the objects in the virtual world and the relationships between the objects can be more efficiently managed.

While the present invention has been described with respect to the specific embodiments, it will be apparent to those skilled in the art that various changes and modifications may be made without departing from the spirit and scope of the invention as defined in the following claims.

What is claimed is:

1. A method for managing a virtual world, comprising:
receiving virtual world management information including user information and communication information; and
managing a virtual world, objects in the virtual world, and relationships between the objects using the virtual world management information.

2. The method of claim 1, wherein the user information includes user profile information, and
the user profile information includes resident registration number information, gender information, age information, address information, phone number information, location information, emotion information, blood pressure information, and heart rate information.

3. The method of claim 1, wherein the communication information includes current status information, interaction information, and expression modality information.

4. The method of claim 3, wherein the current status information includes name information, ID information, location information, property information, interest information, relationship information, and popularity information.

5. The method of claim 4, wherein the interest information includes interest name information, celebrity information, interest group information, and interest field information.

6. The method of claim 4, wherein the relationship information includes relationship name information, interest ID information, virtual world relationship information, and real world relationship information.

7. The method of claim 4, wherein the popularity information includes information about the number of nominations, information about the number of friends, information about the number of interests, information about the number of activities, information about friends rank, and information about an activity rank.

8. The method of claim 3, wherein the interaction information includes avatar-to-avatar relationship information, avatar-to-virtual object relationship information, user-to-avatar relationship information, user-to-virtual object relationship information, and virtual object-to-virtual object relationship information.

9. The method of claim 3, wherein the expression modality information includes linguistic expression information, facial expression information, finger movement information, gesture information, and posture information.

10. The method of claim 9, wherein the linguistic expression information includes voice expression information and text expression information.

11. An apparatus for managing a virtual world, comprising:
an input unit configured to receive virtual world management information including user information and communication information; and
a management unit configured to manage a virtual world, objects in the virtual world, and relationships between the objects using the virtual world management information.

12. The apparatus of claim 11, wherein the user information includes user profile information, and
the user profile information includes resident registration number information, gender information, age information, address information, phone number information, location information, emotion information, blood pressure information, and heart rate information.

13. The apparatus of claim 11, wherein the communication information includes current status information, interaction information, and expression modality information.

14. The apparatus of claim 13, wherein the method of claim 3, wherein the current status information includes name information, ID information, location information, property information, interest information, relationship information, and popularity information.

15. The apparatus of claim 14, wherein the interest information includes interest name information, celebrity information, interest group information, and interest field information.

16. The apparatus of claim 14, wherein the relationship information includes relationship name information, interest ID information, virtual world relationship information, and real world relationship information.

17. The apparatus of claim 14, wherein the popularity information includes information about the number of nominations, information about the number of friends, information about the number of interests, information about the number of activities, information about friends rank, and information about an activity rank.

18. The apparatus of claim 13, wherein the interaction information includes avatar-to-avatar relationship information, avatar-to-virtual object relationship information, user-to-avatar relationship information, user-to-virtual object relationship information, and virtual object-to-virtual object relationship information.

19. The apparatus of claim 13, wherein the expression modality information includes linguistic expression information, facial expression information, finger movement information, gesture information, and posture information.

20. The apparatus of claim 19, wherein the linguistic expression information includes voice expression information and text expression information.
